(19) United States
(12) Patent Application Publication
(10) Pub. No.: US 2025/0127199 A1
(43) Pub. Date: Apr. 24, 2025

(54) COMPOSITION COMPRISING A NUTRIENT AND A TASTE MODULATOR

(71) Applicant: Firmenich SA, Satigny (CH)

(72) Inventors: Maxime DELATTRE, Satigny (CH); Pierre-Etienne BOUQUERAND, Satigny (CH); Ronald SKIFF, Plainsboro, NJ (US)

(21) Appl. No.: 18/684,925

(22) PCT Filed: Oct. 13, 2022
(86) PCT No.: PCT/EP22/78462

§ 371 Date: Feb. 20, 2024

Related U.S. Application Data
(60) Provisional application No. 63/274,315, filed on Nov. 1, 2021.

(30) Foreign Application Priority Data
Nov. 11, 2021 (EP) 21207811.7

(51) Int. Cl. A23L 27/00; A23G 4/06; A23G 4/12; A23J 3/22; A23L 2/56; A23L 27/20

(52) U.S. Cl. CPC A23L 27/86; A23G 4/064; A23G 4/126; A23J 3/227; A23L 2/56; A23L 27/204; A23L 27/2052; A23L 27/84; A23L 27/88

(57) ABSTRACT

Described herein is a composition including a nutrient and a taste modulator. Also described herein are processes for preparing the composition and consumer products containing the composition.

### TECHNICAL FIELD

The technical field of the present invention relates to a composition comprising a nutrient and a taste modulator. Processes for preparing said composition and consumer products containing said composition are also objects of the invention.

### BACKGROUND

The consumer demand for edible products comprising nutrients (for example, minerals and/or vitamins) is more and more important and is driving the development of new delivery systems.

Furthermore, organoleptic feelings associated with a food product are important to many consumers. However, some of the nutrient could have off note and undesired taste.

Finally, when the nutrient is in the form of a liquid, it might be difficult to dose it in the final edible product and the active lifetime of the nutrient can be challenged.

Thus, there is a need in the industry for delivery systems comprising nutrients (such as minerals and/or vitamins for example), safe and easy to handle, with excellent physical and chemical stability, which do not release off note or undesired taste while improving the cost-in-use performance. The present invention satisfies this and other needs of the industry.

### DESCRIPTION OF THE INVENTION

### Composition

A first object of the invention is a composition comprising:
at least one water-soluble carrier material
at least one nutrient, and
at least one taste modulator.

According to an embodiment, the nutrient and the taste modulator are dispersed homogenously within the water-soluble carrier material.

According to a particular embodiment, the composition is a particle. According to another embodiment, the composition is a coating material. The coating can be typically applied on an insoluble food carrier such as for example flowers, leaves, beans, seeds, cereals, powders, and particles, preferably on tea leaves and coffee beans. The leaves may be whole leaves, cut leaves, ground leaves, powdered leaves, in particular in form of free-flowing powders, or particles.

Under “coating”, a coating is understood that homogeneously (fully) coats for example an insoluble food carrier but also a coating that heterogeneously (partially) coats for example an insoluble food carrier.

According to a particular embodiment, the composition comprises a flavor. The flavor is preferably dispersed or embedded within the water-soluble carrier material.

“Water-soluble carrier material” and “Water-soluble matrix material” can be used indifferently in the present invention.

By “flavor or flavoring composition”, it is meant here a flavoring ingredient or a mixture of flavoring ingredients, solvents or adjuvants of current use for the preparation of a flavoring formulation, as being capable of imparting a flavour or taste to a consumer product.

According to an embodiment, the flavor is hydrophobic. According to another embodiment, the flavor is hydrophilic. According to an embodiment, the flavor is a flavor oil.

Flavoring ingredients are well known to a person skilled in the art and their nature does not warrant a detailed description here, which in any case would not be exhaustive, the skilled flavorist being able to select them on the basis of his general knowledge and according to the intended use or application and the organoleptic effect it is desired to achieve. Many of these flavoring ingredients are listed in reference texts such as in the book by S. Arctander, Perfume and Flavor Chemicals, 1969, Montclair, N.J., USA, or its more recent versions, or in other works of similar nature such as Fenaroli's Handbook of Flavor Ingredients, 1975, CRC Press or Synthetic Food Adjuncts, 1947, by M. B. Jacobs, van Nostrand Co., Inc. Solvents and adjuvants of current use for the preparation of a flavoring formulation are also well known in the art.

In a particular embodiment, the flavor is a mint flavor. In a more particular embodiment, the mint is selected from the group consisting of peppermint and spearmint.

In another embodiment, the flavor is a menthol flavor.

Flavors that are derived from or based on fruits where citric acid is the predominant, naturally-occurring acid include but are not limited to, for example, citrus fruits (e.g. lemon, lime), limonene, strawberry, orange, and pineapple. In one embodiment, the flavors food is lemon, lime or orange juice extracted directly from the fruit. Further embodiments of the flavor comprise the juice or liquid extracted from oranges, lemons, grapefruits, key limes, citrons, clementines, mandarins, tangerines, and any other citrus fruit, or variation or hybrid thereof. In a particular embodiment, the flavor comprises a liquid extracted or distilled from oranges, lemons, grapefruits, key limes, citrons, clementines, mandarins, tangerines, any other citrus fruit or variation or hybrid thereof, pomegranates, kiwifruits, watermelons, apples, bananas, blueberries, melons, ginger, bell peppers, cucumbers, passion fruits, mangos, pears, tomatoes, and strawberries.

In a particular embodiment, the flavor comprises a composition that comprises limonene, in a particular embodiment, the composition is a citrus that further comprises limonene.

In another particular embodiment, the flavor comprises a flavor selected from the group comprising strawberry, orange, lime, tropical, berry mix, and pineapple.

According to an embodiment, the composition of the invention comprises between 1 and 18%, preferably 3 and 10% by weight of a flavor based on the total weight of the composition.

According to a particular embodiment, the composition does not comprise a flavor.

### Nutrient

Nutrients according to the invention should be understood as chemical compounds in food that are used by the body to function properly and maintain health.

According to an embodiment, the nutrient is chosen in the group consisting of a vitamin, a mineral, an antioxidant, a botanical extract and mixtures thereof.

According to an embodiment, the composition comprises at least one mineral preferably chosen in the group consisting of iron, selenium, zinc, magnesium, calcium, copper, sodium, potassium, phosphor, silver, gold, sulphur and mixtures thereof.

According to an embodiment, the composition comprises at least one vitamin preferably chosen in the group consisting of vitamin E (tocopherol or alpha-tocopherol-(2R)-2,5,7,8-tetramethyl-2-[(4R,8R)-(4,8,12-trimethyltridecyl)]chroman-6-ol), vitamin B₆ (Pyridoxine or 4,5-Bis(hydroxymethyl)-2-methylpyridin-3-ol), vitamin A (retinol or (2E,4E,6E,8E)-3,7-dimethyl-9-(2,6,6-trimethylcyclohexen-1-yl) nona-2,4,6,8-tetraen-1-ol), vitamin C (ascorbic acid or (5R)-[(1S)-1,2-Dihydroxyethyl]-3,4-dihydroxyfuran-2(5H)-one), vitamin D, vitamin B₁ (Thiamine or 2-[3-[(4-amino-2-methylpyrimidin-5-yl)methyl]-4-methyl-1,3-thiazol-3-ium-5-yl]ethanol), vitamin B₂ (Riboflavin or 7,8-Dimethyl-10-[(2S,3S,4R)-2,3,4,5-tetrahydroxypentyl]benzo[g]pteridine-2,4-dione), vitamin B₃ (Nicotinic acid or pyridine-3-carboxylic acid), vitamin B₅ (Pantothenic acid or 3-[(2,4-dihydroxy-3,3-dimethylbutanoyl)amino]propanoic acid), vitamin B₆ (Pyridoxine or 4,5-Bis(hydroxymethyl)-2-methylpyridin-3-ol), vitamin B₇ (Biotin or 5-[(3aS,4S,6aR)-2-oxohexahydro-1H-thieno[3,4-d]imidazol-4-yl]pentanoic acid), vitamin B₈ (Biotin or 5-[(3aS,4S,6aR)-2-oxohexahydro-1H-thieno[3,4-d]imidazol-4-yl]pentanoic acid), vitamin B₉ (Folate or (2S)-2-[(4-{[(2-amino-4-hydroxypteridin-6-yl)methyl]amino}phenyl)formamido]pentanedioic acid), vitamin B₁₂ (Cyanocobalamin or cobalt(3+);[(2R,3S,4R,5S)-5-(5,6-dimethylbenzimidazol-1-yl)-4-hydroxy-2-(hydroxymethyl) oxolan-3-yl][(2R)-1-[3-[(1R,2R,3R,5Z,7S,10Z,12S,13S,15Z,17S,18S, 19R)-2,13,18-tris(2-amino-2-oxoethyl)-7,12,17-tris(3-amino-3-oxopropyl)-3,5,8,8,13,15,18,19-octamethyl-2,7,12,17-tetrahydro-1H-corrin-24-id-3-yl]propanoylamino]propan-2-yl]phosphate;cyanide), Inositol (Cyclohexanehexol or cis-1,2,3,5-trans-4,6-Cyclohexanehexol), Vitamin D₁ (Mixture 1:1 of molecular compounds of ergocalciferol with lumisterol) vitamin D₂ (Ergocalciferol or (3β,5Z,7E,22E)-9,10-secoergosta-5,7,10(19),22-tetraen-3-ol), vitamin D₃ (cholecalciferol or (3β,5Z,7E)-9,10-secocholesta-5,7,10(19)-trien-3-ol), vitamin D₄ (22-Dihydroergocalciferol or (5Z,7E)-(3S)-9,10-seco-5,7,10(19)-ergostatrien-3-ol), vitamin D₅ (sitocalciferol or (1S,3Z)-3-[(2E)-2-[(1R,3aS,7aR)-1-[(1R,4S)-4-ethyl-1,5-dimethylhexyl]-7a-methyl-2,3,3a,5,6,7-hexahydro-1H-inden-4-ylidene]ethylidene]-4-methylene-1-cyclohexanol), Vitamin K (Phytonadione or 2-methyl-3-[(E,7R,11R)-3,7,11,15-tetramethylhexadec-2-enyl]naphthalene-1,4-dione), and mixtures thereof.

According to an embodiment, the composition comprises at least one vitamin preferably chosen in the group consisting of vitamin E, vitamin B₆, vitamin A, vitamin C, vitamin D, vitamin B₁, vitamin B₂, vitamin B₃, vitamin B₅, vitamin B₆, vitamin B₇, vitamin B₈, vitamin B₉, vitamin B₁₂, Inositol, Vitamin D₁, vitamin D₂, vitamin D₃, vitamin D₄, vitamin D₅, Vitamin K and mixtures thereof. According to an embodiment, the composition comprises at least one vitamin preferably chosen in the group consisting of vitamin E, vitamin B₆, vitamin A, vitamin C, vitamin D, vitamin B₁, vitamin B₂, vitamin B₃, vitamin B₅, vitamin B₆, vitamin B₇, vitamin B₈, vitamin B₉, vitamin B₁₂, Vitamin D₁, vitamin D₂, vitamin D₃, vitamin D₄, vitamin D₅, Vitamin K and mixtures thereof.

Antioxidant that can be used in the invention are well-known from the person skilled in the art. As non-limiting examples of antioxidant, one may cite for example rosemary extract, tecopherol, ascorbic acid and mixtures thereof.

Botanical extract that can be used in the invention are well-known from the person skilled in the art. As non-limiting examples of botanical extract, one may cite for example Rose extract, mango extract, ginger extract, tea extract, Garcinia Cambodgia, cascara, chia seeds, ginko biloba, nettle leaves, acerola, and mixtures thereof.

The amount of nutrient in the composition can vary. The person skilled in the art will be able to determine the suitable amount of nutrient to be added in the composition based on the target dosage of nutrient in the final food and/or beverage application.

Typically, the composition according to the invention comprises between 0.1 and 50%, preferably 0.5 and 30% by weight of nutrient based on the total weight of the composition.

### Carrier Material

According to the invention, the carrier material is water soluble. A “water soluble material” is intended for the purpose of the present invention as encompassing any material which forms a one-phase solution in water. Preferably, it forms a one phase solution when dissolved in water at concentrations as high as 20% by weight, more preferably even as high as 50% by weight. Most preferably it forms a one phase solution when dissolved in water at any concentration.

The amount of water-soluble carrier material in the composition can vary. The person skilled in the art will be able to determine the suitable amount of water-soluble carrier material to be added in the composition.

Typically, the composition according to the invention comprises between 50 and 95%, preferably between 60 and 90% by weight of carrier material based on the total weight of the composition.

According to an embodiment, the water-soluble carrier material is chosen in the group consisting of a starch derivative, gum, fiber, polysaccharide, protein, soluble flour or mixtures thereof.

The term “starch derivative” has the normal meaning of the term to a person skilled in the art. Starch derivatives are prepared by enzymatically, physically or chemically treating native starch to alter its properties. Particular examples of starch derivatives comprise maltodextrin, dextrin, resistant starch, hydroxypropylated starch, phosphate starch phosphate, octenylsuccinated starch, starch aluminium octenyl succinate, acetylated distarch phosphate, acetylated distarch adipate, acetylated distarch adipate, hydroxypropyl distarch phosphate and acetylated oxidized starch.

The term “gum” has the normal meaning of the term to a person skilled in the art. Gums can be derived from botanical sources, seaweeds, and bacteria fermentation. Particular examples of gums comprise gum arabic, gum tragacanth, gum karaya, gum ghatti, ocra gum, glucomannan, gellan gum, alginate, etc.

The term “fiber” has the normal meaning of the term to a person skilled in the art. They cannot be digested by human body's enzymes. Particular examples of fibers comprise inulin, fructooligosaccharides, beta glucan, arabinogalactan, glucomannan, psyllium, soluble corn fiber etc.

The term “polysaccharide” has the normal meaning of the term to a person skilled in the art. Particular examples of polysaccharides comprise tamarind seed polysaccharide, soy polysaccharide, galactomannan, xyloglucan, carrageenan, pectin, curdlan, arabinan, arabinoglactan, etc.

The term “protein” has the normal meaning of the term to a person skilled in the art. Paticular examples of proteins comprise pea protein, soy protein, lentil proteins, chickpea protein, rice protein, potato protein, fava bean protein, mung bean protein, canola protein, etc.

The term “soluble flour” has the normal meaning of the term to a person skilled in the art. Soluble fours are flours with chemical, physical, or enzymatical treatment to increase their solubility and functionality. Particular examples of soluble flours comprise soluble rice flour, soluble brown rice flour, koji rice, etc.

According to an embodiment, the carrier material comprises at least one modified starch and at least one hydrolyzed starch.

According to an embodiment, the carrier material comprises at least one hydrolyzed starch having a DE greater than 6 DE, particularly greater than 10 DE, more particularly greater than 17 DE.

The DE value can be defined as a measure of the reducing equivalent of hydrolyzed starch, referenced to dextrose and expressed as a percentage (based on dry matter), determined by well-known procedures.

The dextrose equivalent DE is typically defined by the following relationship (H. Levine, L. Slade: “Water as a plasticizer: physico-chemical aspects of low moisture polymeric systems”, in Water Science Reviews, 1988, Vol. 3, F. Franks (Ed.), pp. 79-185, Cambridge University Press, Cambridge, England)

DE=(18016)/Mn

wherein DE is Dextrose equivalent and wherein Mn is number average molecular weight.

The value Mn can be easily determined by the person skilled in the art, for example by using SEC Multi-Detector System.

As non-limiting example, the SEC instrument is Viscotek TDA305 max system (Malvern Instruments, Ltd, UK) with Viscotek Triple Detector Array (TDA) incorporating Refractive Index (RI), Light Scattering (LS), and Viscosity (VS) detectors. A typical method to determine Mn would be the following: the chromatographic system consists of A2000 (CLM3015) and A6000 (CLM3020) (300 mm L×8.0 mm ID, Malvern Instruments Ltd.) put in series after a A7 guard column, with claimed exclusion limits for pullulan of 4 KDa and 2000 KDa respectively. The eluent is 0.1 M sodium nitrate with a flow rate of 0.4 ml/min. The injected volume is 100 μl with sample concentration of around 2 mg/mL. All measurements were conducted at 35° C. Reproducibility of the method is acceptable with standard deviation of 0.06% on retention volume at peak maximum for three consecutive injections.

The term “hydrolyzed starch” means an oligosaccharide-type material typically obtained by acid and/or enzymatic hydrolysis of starch, preferably corn starch.

According to a particular embodiment, the hydrolyzed starch is chosen in the group consisting of maltodextrins, dextrins, corn syrup and mixture thereof.

According to an embodiment, the carrier material comprises also a modified starch.

The term “modified starch” has the normal meaning of the term to a person skilled in the art, i.e a starch that has been physically modified (physical modification), enzymatically modified (enzymatic modification) or chemically modified (chemical modification).

“Physically modified starch” means a starch which has been subjected to a heat treatment in the presence of relatively small amounts of water or moisture. No other reagents are added to the starch during the heat treatment. The heat-treatment processes include heat-moisture and annealing treatments, both of which cause a physical modification of starch without any gelatinization.

“Enzymatically modified starch” means a starch which has been treated with one or more enzymes to modify its properties.

“Chemically modified starch” means a starch which has been reacted with reagents which have been added to the starch in order to form new covalent bonds between those molecules and the starch molecules.

Particular examples of modified starches comprise dextrin, hydroxypropylated starch, phosphate starch phosphate, octenylsuccinated starch, starch aluminium octenyl succinate, acetylated distarch phosphate, acetylated distarch adipate, acetylated distarch adipate, hydroxypropyl distarch phosphate and acetylated oxidized starch. Some non-limited examples include octenylsuccinic anhydride-modified starches such as MiraCap® by Tate & Lyle, Capsul® by Ingredion, EmCap® by Cargill, etc.

According to an embodiment, the modified starch is a chemically modified starch. The chemical modification can increase notably its hydrophobicity to act as stabilizer and emulsifier.

According to this embodiment, the chemically modified starch is chosen in the group consisting of Octenyl succinated starches.

According to a particular embodiment, the modified starch is not agglomerated or compressed.

According to an embodiment, the modified starch is agglomerated or compressed.

In a particular embodiment, the carrier material comprises a maltodextrin with a dextrose equivalent (DE) of about 1 to about 20.

In a particular embodiment, the maltodextrin is selected from a maltodextrin with a DE of about 10 up to about 18 DE.

In another embodiment, the carrier material comprises corn syrup with a DE from 21 up to 49. Any carrier material can be used that is made by the hydrolysis of starches from different origins such as, but not limited to, maize, wheat, potato or rice. In another embodiment, the carrier material is a hydrogenated starch hydrolysate (e.g., HSPolyols), fructose oligosacharides (e.g., but not limited to Inulin from Orafit), soluble fibers such as for example but not limited to Nutriose (Roquette) and pregelatinized starch.

According to a particular embodiment, the carrier material is a mixture of modified starch and a maltodextrin, wherein the maltodextrin has a DE comprised between 1 and 20, particularly between 10 and 20 DE.

According to a particular embodiment, the carrier material is a mixture of modified starch and a maltodextrin, wherein the maltodextrin has a DE comprised between 17 and 20 DE.

A maltodextrin or a blend of maltodextrins having different DE values can be used.

According to a particular embodiment, the carrier material does not comprise a maltodextrin having a DE less than or equals to 6 DE.

According to a particular embodiment, the modified starch is used in an amount less than 50% based on the total weight of the carrier material.

According to a particular embodiment, the modified starch is used in an amount comprised between 10 and 70%, preferably between 10 and 50%, preferably between 10 and 49%, more preferably between 30 and 49%, even more preferably between 30 and 40% and/or the hydrolyzed starch, preferably a maltodextrin, is used in an amount comprised between 30 and 90%, preferably between 50 and 90%, preferably between 51 and 90%, more preferably between 51 and 70%, even more preferably between 60 and 70% by weight based on the total weight of the carrier material.

According to a particular embodiment, the carrier material comprises between 30 and 40% of a modified starch, and between 60 and 70% of a maltodextrin having preferably a DE between 1 and 20 DE, particularly between 17 and 20 DE.

According to an embodiment, the composition according to the present invention may comprise an additional component preferably chosen in the group consisting of gums, proteins, small molecule surfactant, plant extract, saponins, plant-derived proteins, protein hydrolysates, citrus fiber, sugar beet fiber or mixtures thereof and preferably used in an amount comprised between 1 to 30 wt. %, preferably 5 to 20 wt. % and more preferably 10 to 20 wt. % (based on the total weight of the composition). Those additional components may act as stabilizers or emulsifiers.

The term “gums” has the normal meaning of the term to a person skilled in the art. Particular examples of gums comprise gum arabic, gum karaya, gum ghatti, gum tragacanth, okra gum, etc. The term “proteins” has the normal meaning of the term to a person skilled in the art. Particular examples of proteins comprise pea protein, soy protein, lentil proteins, chickpea protein, rice protein, potato protein, fava bean protein, mung bean protein, canola protein, etc. The term “small molecule surfactant” has the normal meaning of the term to a person skilled in the art. Particular examples of small molecule surfactants comprise quillaja saponins, yucca saponins, phospholipids, lecithin, lysolecithin, diacetyltartaric and fatty acid esters of glycerol (DATEM), citric acid esters of mono and diglycerides (CITREM), etc.

In a particular embodiment, the composition comprises a lubricant. The lubricant may be an oil, liquid fat, triglycerides, fatty acids or mixtures thereof. In another embodiment, the lubricant comprises a micellar surfactant like lecithin or a fatty acid ester (e.g., citric, tartaric, acetic), DATEM, CITREM or mixtures of the above. In a particular embodiment, the lubricant may be provided in an amount, by weight, up to about 5%, particularly about 0.2 up to about 5%, more particularly from about 0.8% up to about 2% and even more particularly from about 1 to 2% by weight of the total weight of the composition.

According to an embodiment, the carrier material comprises a low molecular weight carbohydrate. The low molecular weight carbohydrate can be chosen in the group consisting of sucrose, glucose, lactose, maltose, fructose, ribose, dextrose, isomalt, sorbitol, mannitol, xylitol, lactitol, maltitol, pentatol, arabinose, glucose syrup, pentose, xylose, galactose, Trehalose® and mixtures thereof and are used preferably between 1% and 10%, more preferably between 2% and 6% by weight based on the total weight of the composition.

According to a particular embodiment, the carrier material does not comprise a yeast.

In a particular embodiment, the composition may further comprise water.

It is understood that the composition may comprise only such amount of water so that it is still in form of a solid composition and not in the form of a liquid.

In a particular embodiment, the composition according to the present invention is a stable composition. By “stable composition” it is herein understood that the composition is stable against loss of sensory performance at room temperature in dry environment for at least 12 months.

### Taste Modulator

A taste modulator should be understood as a compound capable of modifying the taste that other ingredients provide, typically the nutrient.

It exists different tastes. Among them, one may cite for example the five main basic tastes (sweet, sour, salty, bitter, and umami) but also the trigeminal sensations such as for example cooling, astringency and spiciness. A taste modulator can be understood as any substance interfering with the perception of a taste.

The taste modulator can be chosen in the group consisting of bitterness masker compound, sourness masker compound, umami enhancer compound, cooling enhancer compound, bitterness blocking compound, bitter masking compound, sour taste modulating compound, mouthfeel modifying compound, flavor masking compound, astringency masker compound, salty or metallic taste masker compound, sweetness enhancer compound, salivating enhancer compound and mixtures thereof.

In some embodiments, the composition comprises a sweetness enhancer. Any suitable sweetness enhancer can be used in the composition disclosed herein, including synthetic sweetness enhancers, natural sweetness enhancers, or any combinations thereof.

Examples of suitable synthetic sweetness enhancers include, but are not limited to, N-(1-((4-amino-2,2-dioxo-1H-benzo[c][1,2,6]thiadiazin-5-yl)oxy)-2-methylpropan-2-yl)isonicotinamide, or any of its comestbly acceptable salts, 3-hydroxybenzoic acid, or any compounds set forth in U.S. Pat. Nos. 8,541,421; 8,815,956; 9,834,544; 8,592,592; 8,877,922; 9,000,054; and 9,000,051, as well as U.S. Patent Application Publication No. 2017/0119032.

Suitable examples of natural sweetness enhancers include, but are not limited to, hesperetin dihydrochalcone, hesperetin dihydrochalcone-4′-O′glucoside, neohesperetin dihydrochalcone, brazzein, hesperidin, phyllodulcin, naringenin, naringin, phloretin, glucosylated steviol glycosides, (2R,3R)-3-acetoxy-5,7,4′-trihydroxyflavanone, (2R,3R)-3-acetoxy-5,7,3′-trihydroxy-4′-methoxyflavanone, rubusosides, thaumatin, monellin, miraculin, glycyrrhizin and comestible acceptable salts thereof (such as the mono-ammonium salt), naringin dihydrochalcone, myricetin, nobiletin, polymethoxyflavones, mixed methoxy-and hydroxyflavones, quercetin, certain amino acids, and the like. As used herein, the term “glucosylated steviol glycoside” refers to the product of enzymatically glucosylating natural steviol glycoside compounds. The glucosylation generally occurs through a glycosidic bond, such as an α-1,2 bond, an α-1,4 bond, an α-1.6 bond, a β-1,2 bond, a β-1,4 bond, a β-1,6 bond, and so forth.

In some embodiments of any of the preceding embodiments, the composition comprises 3-((4-amino-2,2-dioxo-1H-benzo[c][1,2,6]thiadiazin-5-yl)oxy)-2,2-dimethyl-N-propyl-propanamide, N-(1-((4-amino-2,2-dioxo-1H-benzo[c][1,2,6]-thiadiazin-5-yl)oxy)-2-methyl-propan-2-yl)isonicotinamide, or a comestibly acceptable salt thereof. In some embodiments, the flavor-modifying composition comprises N-(1-((4-amino-2,2-dioxo-1H-benzo[c][1,2,6]thiadiazin-5-yl)oxy)-2-methyl-propan-2-yl)isonicotinamide, or a comestbly acceptable salt thereof. In some embodiments, the flavor-modifying composition comprises N-(1-((4-amino-2,2-dioxo-1H-benzo[c][1,2,6]thiadiazin-5-yl)oxy)-2-methyl-propan-2-yl)isonicotinamide.

In some embodiments, the composition comprises one or more umami enhancing compounds. Such umami enhancing compounds include, but are not limited to, naturally derived compounds, or synthetic compounds, such as any compounds set forth in U.S. Pat. Nos. 8,735,081; 8,124,121; and 8,968,708. In some embodiments, the umami-enhancing compound is (2R,4R)-1,2,4-trihydroxy-heptadec-16-ene, (2R,4R)-1,2,4-trihydroxyheptadec-16-yne, or a mixture thereof. In some embodiments, the umami-enhancing compound is (3R,5S)-1-(4-hydroxy-3-methoxyphenyl)decane-3,5-diol diacetate. In some embodiments, the umami-enhancing compound is N-(heptan-4-yl)benzo-[d][1,3]dioxole-5-carboxamide.

In some further embodiments, the composition comprises one or more cooling enhancing compounds. Such cooling enhancing compounds include, but are not limited to, naturally derived compounds, such as menthol or analogs thereof, or synthetic compounds, such as any compounds set forth in U.S. Pat. Nos. 9,394,287 and 10,421,727. Non-limiting examples include N-ethyl-N-(thiophen-2-ylmethyl)-2-(p-tolyloxy)acetamide, N-(1H-pyrazol-3-yl)-N-(thiophen-2-ylmethyl)-2-(p-tolyloxy)acetamide, 2-(4-fluorophenoxy)-N-(1H-pyrazol-3-yl)-N-(thiophen-2-ylmethyl)acetamide, 2-(2-hydroxy-4-methylphenoxy)-N-(1H-pyrazol-3-yl)-N-(thiophen-2-ylmethyl)-acetamide, 2-((2,3-dihydro-1H-inden-5-yl)oxy)-N-(1H-pyrazol-3-yl)-N-(thiophen-2-ylmethyl)-acetamide, 2-((2,3-dihydro-1H-inden-5-yl)oxy)-N-(1H-pyrazol-3-yl)-N-(thiazol-5-ylmethyl)-acetamide, 2-((5-methoxybenzofuran-2-yl)oxy)-N-(1H-pyrazol-3-yl)-N-(thiophen-2-ylmethyl)-acetamide, (E/Z)-2-methyl-2-butenal, (E/Z)-2-isopropyl-5-methyl-2-hexenal, phloretin, naringenin, and any combinations thereof.

In some further embodiments, the composition comprises one or more bitterness blocking or bitter masking compounds. Such bitterness blocking compounds or bitter masking include, but are not limited to, naturally derived compounds or synthetic compounds, such as any compounds set forth in U.S. Pat. Nos. 8,076,491; 8,445,692; and 9,247,759. Non-limiting examples include 3-(1-((3,5-dimethylisoxazol-4-yl)-methyl)-1H-pyrazol-4-yl)-1-(3-hydroxybenzyl)-imidazolidine-2,4-dione, 4-(2,2,3-trimethyl-cyclopentyl)butanoic acid, 3β-hydroxydihydrocostunolide, 3β-hydroxypelenolide, probenecid, sakuranetin, 6-methoxysakuranetin, jaceosidin, 4′-fluoro-6-methoxyflavonone, 6,3′-dimethoxyflavonone, 6-methoxyflavonone, γ-aminobutyric acid, Nα,Nα-bis(carbomethyl)-L-lysine, (+/−) abscisic acid, sodium gluconate, monosodium glutamate, sodium acetate, homoeriodictyol, sterubin, eriodictyol, 2,4,dihydrobenzoic acid, neodiosmin, 1-carboxymethyl-5-hydroxy-2-hydroxymethylpyridinium, flavan-3-spiro-C-glycosides, poly-γ-glutamic acid, α,α-trehalose, taurine, (2)-gingerdione, 2,4,-dihydroxybenzoic acid, L-theanine, enterodiol, lariciresinol, enterolactone, matairesinol, and any combinations thereof.

According to an embodiment, the taste modulator is chosen in the group consisting of N-(1-((4-amino-2,2-dioxo-1H-benzo[c][1,2,6]thiadiazin-5-yl)oxy)-2-methylpropan-2-yl)isonicotinamide, or any of its comestbly acceptable salts, 3-hydroxybenzoic acid, or any compounds, hesperetin dihydrochalcone, hesperetin dihydrochalcone-4′-O′glucoside, neohesperetin dihydrochalcone, brazzein, hesperidin, phyllodulcin, naringenin, naringin, phloretin, glucosylated steviol glycosides, (2R,3R)-3-acetoxy-5,7,4′-trihydroxyflavanone, (2R,3R)-3-acetoxy-5,7,3′-trihydroxy-4′-methoxyflavanone, rubusosides, thaumatin, monellin, miraculin, glycyrrhizin and comestible acceptable salts thereof (such as the mono-ammonium salt), naringin dihydrochalcone, myricetin, nobiletin, polymethoxyflavones, mixed methoxy- and hydroxyflavones, quercetin, 3-((4-amino-2,2-dioxo-1H-benzo[c][1,2,6]thiadiazin-5-yl)oxy)-2,2-dimethyl-N-propyl-propanamide, (2R,4R)-1,2,4-trihydroxy-heptadec-16-ene, (2R,4R)-1,2,4-trihydroxyheptadec-16-yne, (3R,5S)-1-(4-hydroxy-3-methoxyphenyl)decane-3,5-diol diacetate, N-(heptan-4-yl)benzo-[d][1,3]dioxole-5-carboxamide, N-ethyl-N-(thiophen-2-ylmethyl)-2-(p-tolyloxy)acetamide, N-(1H-pyrazol-3-yl)-N-(thiophen-2-ylmethyl)-2-(p-tolyloxy)acetamide, 2-(4-fluorophenoxy)-N-(1H-pyrazol-3-yl)-N-(thiophen-2-ylmethyl)acetamide, 2-(2-hydroxy-4-methylphenoxy)-N-(1H-pyrazol-3-yl)-N-(thiophen-2-ylmethyl)acetamide, 2-((2,3-dihydro-1H-inden-5-yl)oxy)-N-(1H-pyrazol-3-yl)-N-(thiophen-2-ylmethyl)-acetamide, 2-((2,3-dihydro-1H-inden-5-yl)oxy)-N-(1H-pyrazol-3-yl)-N-(thiazol-5-ylmethyl)-acetamide, 2-((5-methoxybenzofuran-2-yl)oxy)-N-(1H-pyrazol-3-yl)-N-(thiophen-2-ylmethyl)-acetamide, (E/Z)-2-methyl-2-butenal, (E/Z)-2-isopropyl-5-methyl-2-hexenal, 3-(1-((3,5-dimethylisoxazol-4-yl)-methyl)-1H-pyrazol-4-yl)-1-(3-hydroxybenzyl)-imidazolidine-2,4-dione, 4-(2,2,3-trimethyl-cyclopentyl)butanoic acid, 3β-hydroxydihydrocostunolide, 3β-hydroxypelenolide, probenecid, sakuranetin, 6-methoxysakuranetin, jaceosidin, 4′-fluoro-6-methoxyflavonone, 6,3′-dimethoxyflavonone, 6-methoxyflavonone, γ-aminobutyric acid, Nα,Nα-bis(carbomethyl)-L-lysine, (+/−) abscisic acid, sodium gluconate, monosodium glutamate, sodium acetate, homoeriodictyol, sterubin, eriodictyol, 2,4,dihydrobenzoic acid, neodiosmin, 1-carboxymethyl-5-hydroxy-2-hydroxymethylpyridinium, flavan-3-spiro-C-glycosides, poly-γ-glutamic acid, α,α-trehalose, taurine, (2)-gingerdione, 2,4,-dihydroxybenzoic acid, L-theanine, enterodiol, lariciresinol, enterolactone, matairesinol, and mixtures thereof.

In some further embodiments, the composition comprises one or more sour taste modulating compounds.

In some further embodiments, the composition comprises one or more mouthfeel modifying compounds. Such mouthfeel modifying compounds include, but are not limited to, tannins, cellulosic materials, bamboo powder, and the like.

In some further embodiments, the composition comprises one or more flavor masking compounds. Such flavor masking compounds include, but are not limited to, cellulosic materials, materials extracted from fungus, materials extracted from plants, citric acid, carbonic acid (or carbonates), and the like.

According to a particular embodiment, the taste modulator is chosen in the group consisting of phloretin, naringenin, and mixtures thereof.

The person skilled in the art will be able to select the suitable amount of taste modulator that masks the off notes exhibited/associated with the nutrient contained in the composition.

Typically, the composition comprises between 0.5 and 25%, preferably between 2 and 15% by weight of a taste modulator based on the total weight of the composition.

The composition of the present invention can be obtained by different methods such as mixing, extrusion, spray-drying, fluidizing bed drying.

According to an embodiment, the composition is an extruded particle and has preferably a size between 0.25 and 50 mm, more preferably between 0.25 and 10 mm, even more preferably between 0.5 mm and 3 mm.

According to another embodiment, the composition is a spray-dried particle and has preferably a size comprised between 5 and 300 microns, preferably between 10 and 100 microns.

The particle size can be measured via any well-established method that allows measurements which are accurate within an experimental error of 5% at the most and preferably below 1%. Suitable well-established methods use laser diffraction particle size analyser (e.g. Coulter LS 13 320 from Beckman Coulter, Brea, CA, USA). Upon analysis the volume statistics (d_{4,3}) was determined to characterize the particle size. When the size of some particles exceeds 2 mm, their distribution should be evaluated by sieving using a range of sieves of different mesh to collect and weight the different fractions. For a repeatable separation vibratory sieve shaker like Reitsch AS 200 basic (Germany) can be used.

According to another embodiment, the composition (mixture of at least a nutrient, a taste modulator and a water-soluble carrier material) is used as a coating. The mixture can be poured, sprinkled, or sprayed through a nozzle on an insoluble food carrier.

The insoluble food carrier is preferably selected from the group consisting of flowers, leaves, beans, seeds, cereals, algae, fruit pieces, vegetable pieces, powders, and particles, more preferably preferably the insoluble food carrier is selected from the group consisting of tea leaves and coffee beans. The leaves may be whole leaves, cut leaves, ground leaves, powdered leaves, in particular in form of free-flowing powders, or particles. The coffee beans may be unground or ground coffee beans.

In a particular embodiment, the insoluble food carrier is selected from the group consisting of an herbal carrier, a fruit carrier, and other botanicals.

In a particular embodiment, the insoluble food carrier may be algae, preferably seaweed.

In a particular embodiment, the insoluble food carrier is one or more fruit pieces. The one or more fruit pieces may stem from the same type of fruit or from different types of fruits. The one or more fruit pieces may stem from e.g. apples, pears, oranges, mandarins, limes, nectarines, apricots, peaches, plums, bananas, mangoes, strawberries, raspberries, blueberries, kiwifruit, passionfruit, and/or watermelons.

In a particular embodiment, the insoluble food carrier is one or more vegetable pieces. The one or more vegetable pieces may stem from the same type of vegetable or from different types of vegetables.

### Process for Preparing the Composition

The embodiments described above for the composition according to the invention also apply to the process according to the invention. This particularly applies to the carrier material, the nutrient, the taste modulator and the flavor (when present in the composition).

The composition may be prepared by any suitable method readily selected by one of ordinary skill in the art. Non-limiting examples of methods include mixing, extrusion, spray drying, and the like.

The present invention relates to a process for preparing a composition as described herein above, wherein the composition is prepared by the steps of:
a) Mixing the water-soluble carrier material, the nutrient, the taste modulator and optionally the flavor, optionally in a twin-screw extruder,
b) optionally, homogenizing the resulting mixture in water, optionally in the presence of an emulsifier,
c) optionally, drying the resulting, optionally homogenized mixture.

According to another embodiment, the composition is a particle and is prepared by extrusion, preferably twin-screw extrusion or hot-melt extrusion.

According to an embodiment, the composition is a particle and is prepared by spray drying.

### Extrusion Process

According to another embodiment, the composition is prepared by twin-screw extrusion according to the methods disclosed for example in International Patent Application Publication No. WO2016/102426 A1. According to an embodiment, the composition is an extruded particle.

Thus, another object of the invention is a process for preparing extruded particles, wherein the process comprises the steps of:
a) preparing a mixture comprising.
   at least one water-soluble carrier material
   at least one nutrient, and
   at least one taste modulator
   optionally, a flavor;
b) heating said mixture within a screw extruder to a temperature preferably comprised between 90 and 130° C. to form a molten mass;
c) extruding the molten mass through a die;
d) chopping the molten mass as it exits the die to provide extruded particles.
   According to an embodiment, the process comprises an additional step between step b) and step c) consisting of pumping the molten mass and pushing said molten mass through a static mixer. The pumping step can be carried out by using a gear pump, preferably a polymer gear pump, which allows to take the melt coming out of the extruder and pushing it through the static mixer or can be also done only thanks to the effect of the twin-screw extruder itself. The extruded particles may be formed at the die face of the extruder while still hot using for example cutting process.

In one embodiment the extruded particles have a size of about 0.5 to 5 mm

In one embodiment the glass transition temperature of the particle is substantially the same as the glass transition temperature of the mixture. This is attained by ensuring low- or no-loss of water.

According to this particular embodiment, a small amount of water is added to the mixture to guarantee that the glass transition temperature (T_{g}) of the resulting melt corresponds to and is substantially the same as that of the desired T_{g} value of the final product. In other words, contrary to other methods such as wet-granulation, the glass transition temperature of the mixture before extrusion has already the value required for the final product, which temperature is above room temperature and preferably above 40° C. so that the product can be stored at ambient temperature in the form of free-flowing particles. As a consequence, this embodiment of the invention can dispense with the additional drying step following the extrusion, intended to remove water in order to increase T_{g} to an acceptable value.

The mixture is thus extruded in an extruder assembly which maintains the temperature of the mixture at a predetermined temperature which is comprised preferably between 90 and 130° C. This temperature is particularly adapted to the system of the invention: first of all, it is preferably above the glass transition temperature of the water-soluble carrier material in order to keep the mixture in the form of a molten mass. Pressure is also applied and adjusted to a value appropriate to maintain homogeneity of the melt. Typically, pressure values of up to 100 bar (10⁷ Pa) can be used depending on the size of the equipments (for example one may need to increase the pressure to 200 bar for larger scale extruders).

In this particular embodiment, as the mixture comes to the die part of the extruder, the temperature is still above the glass transition temperature of the carrier material. Typically, the extruder is equipped with a cutter-knife and the mixture is thus cut at the temperature of the melt. Typically, once cooled to ambient temperature by the surrounding air, the already cut glassy material does not need to be shaped or dried in a spheroniser, fluid-bed dryer or other device, unlike what is the case with other processes where the molten matrix is cooled prior to the cutting. In a particular embodiment the surrounding air comprises chilled air.

The glass transition temperature of the mixture (with optionally the flavor) depends on the amount of water added to the initial mixture. In fact, it is well known in the art that the T_{g} decreases when the proportion of water increases. In the latter embodiment of the invention, the proportion of water added to the mixture will be low, i.e. such that the glass transition temperature of the resulting mixture is substantially equal to the glass transition temperature desired for the final particles, i.e. the extruded product.

According to an embodiment, the resulting encapsulated compound or composition has a glass transition temperature T_{g} significantly above the temperature at which it will be stored and subsequently used. The critical temperature (T_{g}) is preferably at least above room temperature and preferably above 40° C. The proportions in which water is employed in the present invention therefore vary in a wide range of values which the skilled person is capable of adapting and choosing as a function of the carrier material and the required T_{g} of the final product.

As cited before the extruding step of this process requires an extruding apparatus. A commercially acceptable extruding apparatus is that under the trade name designation Clextral BC 21 twin-screw extruder equipped with a cutter-knife allowing to chop the melt at the die exit, when it is still plastic. The product which is cut is thus still at a temperature which is above the glass transition temperature of the matrix.

Extruding apparatuses are not limited to the twin screw variety and may also include, for example, single screw, ram, or other similar extrusion methods.

During the extrusion process, the mixture is forced through a die having an orifice with a predetermined diameter which ranges typically from about 0.250 to 10 mm, more particularly from about 0.5 up to about 2.0 mm and more particularly from 0.7 to 2.0 mm. However, much larger diameters for the die are also possible.

The length of the pieces is typically regulated by controlling the stroke rate of the specific cutting apparatus.

Typically, the severed pieces are subsequently cooled to ambient temperature by the surrounding air. According to an embodiment, no drying or further treatment is needed.

In another embodiment, a lubricant is provided herein. While not wishing to be bound to any theory it is believed that the lubricant reduces shear and expansion of the molten mass at the exit die. The lubricant may be an oil, liquid fat, triglycerides, fatty acids or mixtures thereof. In some embodiments, the lubricant may comprise a medium chain triglyceride (MCT). In another embodiment, the lubricant comprises a micellar surfactant like lecithin or a fatty acid ester (e.g., citric, tartaric, acetic), DATEM, CITREM, or mixtures of the above. In a particular embodiment, the lubricant may be provided in an amount, by weight, up to about 5%, particularly about 0.2 up to about 5%, more particularly from about 0.8% up to about 2% and even more particularly from about 1 to 2% of the total weight of the particle. In the embodiment the lubricant is provided in an amount of 2% of the total weight of the particle. In another embodiment the lubricant is provided in an amount of 1% of the total weight of the particle.

### Hot Melt Extrusion

According to another embodiment, the composition is a particle and is prepared by hot melt extrusion for example according to the methods disclosed in International Patent Application Publication No. WO2004/082393.

The particle may be prepared by hot melt extrusion process comprising the following steps:
a) preparing an aqueous solution of at least one water-soluble carrier material to form a syrup;
b) heating the syrup to form a concentrated solution or melt;
c) uniformly dispersing a nutrient, a taste modulator and optionally a flavor throughout the melt to form a melt-active mixture;
d) cooling the melt-active mixture to a temperature to which the mixture is in a molten state;
e) extruding the molten mixture into a cool organic solvent wherein the extruded molten mass is broken up into particles; and
f) drying the particles:

According to a particular embodiment, steps a) to f) are carried out continuously and steps b) and d) are carried out by passing the syrup in step b), respectively the melt-active mixture in step d), onto the surface of a heat-exchanger.

According to an embodiment, step b) is carried out on a swept surface heat exchanger.

According to an embodiment, step d) is carried out on a scraped surface heat exchanger.

According to an embodiment, the syrup is heated in step b) to a temperature comprised between 105 and 150° C.

According to an embodiment, the mean residence time of the syrup in the heat exchanger in step b) is comprised between 1 and 10 min.

According to an embodiment, the aqueous solution of step a) contains from 12 to 40% by weight of water relative to the total weight of the solution.

According to an embodiment, the aqueous solution of step a) is prepared by means of conveying the starting materials from a dry solid weight tank to a mixing tank and a heating tank, and then pumping from the heating tank through a multitube heat exchanger and back to the hot tank in a loop.

According to an embodiment, the melt at the end of step b) has a moisture content comprised between 2 and 11% by weight.

According to an embodiment, step c) is carried out by means of a high shear homogenizer wherein the residence time of the mixture is of less than 1 min.

According to an embodiment, the melt-active mixture is cooled to a temperature comprised between 102 and 135° C.

According to an embodiment, at least 90% by weight of the flavor ingredient or composition dispersed through the melt in step c), is effectively encapsulated in the prepared particulate composition.

According to an embodiment, the extrusion step is carried out at a pressure comprised between 1×10⁵ Pa and 3×10⁵ Pa.

### Spray-Drying Process

According to an embodiment, the composition is a particle and is prepared by spray drying for example according to the methods disclosed in U.S. Patent Application Publication No. 2015/0374018 A1.

The particle may be prepared by a process comprising the steps of:
(i) preparing a composition comprising:
   water,
   a carrier material,
   a nutrient,
   a taste modulator
   optionally, a flavor,
(ii) drying the composition obtained in step i) so as to obtain a powdered composition.

According to an embodiment, the composition of step i) is an emulsion.

The composition of step i) can be formed using any known emulsifying method, such as high shear mixing, sonication or homogenization. Such emulsifying methods are well known to the person skilled in the art.

According to an embodiment, the composition of step i) has a viscosity comprised between 50 mPa·s and 500 mPa·s at 65° C. with shear rate of 100 s⁻¹ The flow viscosity was measured using a TA Instruments AR2000 rheometer (New Castle, DE, USA) with concentric cylinder geometry.
The person skilled in the art will be able to select a suitable amount of water, carrier material, nutrient, taste modulator and optionally a flavor to obtain a particle having typically:
between 0.1 and 50%, preferably 0.5 and 30% by weight of nutrient based on the total weight of the particle
between 50 and 95%, preferably 60 and 90% by weight of carrier material based on the total weight of the particle
between 0.5 and 25%, preferably 2 and 15% by weight of taste modulator based on the total weight of the particle
optionally between 1 and 18%, preferably 3 and 10% by weight of a flavor based on the total weight of the particle.

The emulsion may also contain optional ingredients. It may in particular further contain an effective amount of a fireproofing or explosion suppression agent. The type and concentration of such agents in spray-drying emulsions is known to the person skilled in the art. One can cite as non-limiting examples of such fireproofing or explosion suppression agents inorganic salts, C₁-C₁₂ carboxylic acids, salts of C₁-C₁₂ carboxylic acids and mixtures thereof. Preferred explosion suppression agents are, salicylic acid, acetic acid, propionic acid, butyric acid, isobutyric acid, valeric acid, caproic acid, citric acid, succinic acid, hydroxysuccinic acid, maleic acid, fumaric acid, oxylic acid, glyoxylic acid, adipic acid, lactic acid, tartaric acid, ascorbic acid, the potassium, calcium and/or sodium salts of any of the afore-mentioned acids, and mixtures of any of these.

Other optional ingredients include antioxidants, preservatives, colorants and dyes.

The droplet size d(v,0.9) of the emulsion is preferably comprised between 0.5 and 15 μm, more preferably between 0.5 and 10 μm.

According to an embodiment, in step ii), the emulsion is spray-dried so as to obtain a powdered composition.

When spray-drying is used, the emulsion is first subjected to a spraying step during which the emulsion is dispersed in the form of drops into a spraying tower. Any device capable of dispersing the emulsion in the form of drops can be used to carry out such dispersion. For instance, the emulsion can be guided through a spraying nozzle or through a centrifugal wheel disk. Vibrated orifices may also be used.

According to an embodiment, the emulsion is dispersed in the form of drops into a cloud of powdering agent present in the dry tower. Such type of process is for example described in details in WO2007/054853 or in WO2007/135583.

For a specific formulation, the size of the particles is influenced by the size of the drops that are dispersed into the tower. When a spraying nozzle is used for dispersing the drops, the size of such drops can be controlled by the flow rate of an atomising gas through the nozzle, for example. In the case where a centrifugal wheel disk is used for dispersal, the main factor for adjusting droplet size is the centrifugal force with which the drops are dispersed from the disk into the tower. The centrifugal force, in turn, depends on the speed of rotation and the diameter of the disk. The feed flow rate of the emulsion, its surface tension and its viscosity are also parameters controlling the final drop size and size distribution. By adjusting these parameters, the skilled person can control the size of the drops of the emulsion to be dispersed in the tower.

Once sprayed in the chamber, the droplets can be dried using any technique known in the art. These methods are perfectly documented in the patent and non-patent literature in the art of spray-drying. For example, Spray-Drying Handbook, 3^{rd} ed., K. Masters; John Wiley (1979), describes a wide variety of spray-drying methods.

The process of the present invention may be performed in any conventional spraying tower. A conventional multi-stage drying apparatus is for example appropriate for conducting the steps of this process. It may comprise a spraying tower, and, at the bottom of the tower, a fluidised bed intercepting partially dried particles after falling through the tower.

The amount of flavour lost during the spray drying step is preferably below 15%, more preferably below 10%, most preferably below 5%, these percentages being defined by weight, relative to the theoretical amount that would be present in the particle if there was absolutely no flavour lost during the spray-drying step.

### Edible Consumer Product

The present invention relates to an edible consumer product comprising the composition as described herein-above and, optionally, a flavor base consumer product. According to an embodiment, the edible consumer product is a flavored edible consumer product

The edible consumer product, preferably the flavored consumer product may be a beverage or food product.

In a particular embodiment, the edible consumer product, preferably flavored consumer product may be suitable for conveying flavors to beverages, fluid dairy products, condiments, baked goods, frostings, bakery fillings, candy, chewing gum and other food products.

In a particular embodiment, the edible consumer product, preferably flavored consumer product is selected from the group consisting of: protein powders, protein drinks, cereals, protein bars, meat analogues, seafood analogues and savory goods. Meat analogues can include pork analogues, venison analogues, beef analogues, veal analogues, rabbit analogues, sausage analogues, deli meat analogues, ham analogues, salami analogues, pepperoni analogues, chicken analogues, turkey analogues, goose analogues, pheasant analogues, pigeon analogues, whale analogues, lamb analogues, goat analogues, donkey analogues, and squirrel analogues. Seafood analogues can include fish analogues, scallop analogues, shrimp analogues, crabmeat analogues, shellfish analogues, clam analogues, squid analogues, conch analogues, and sea pineapple analogues.

When the food product is a particulate or powdery food, the dry composition may easily be added thereto by dry-mixing. Typical food products are selected from the group consisting of an instant soup or sauce, a breakfast cereal, a powdered milk, a baby food, a powdered drink, a powdered chocolate drink, a spread, a powdered cereal drink, a chewing gum, an effervescent tablet, a cereal bar, and a chocolate bar. The powdered foods or drinks may be intended to be consumed after reconstitution of the product with water, milk and/or a juice, or another aqueous liquid.

Beverages include, without limitation, carbonated soft drinks, including cola, lemon-lime, root beer, heavy citrus (“dew type”), fruit flavored and cream sodas; powdered soft drinks, as well as liquid concentrates such as fountain syrups and cordials; coffee and coffee-based drinks, coffee substitutes and cereal-based beverages; teas, including dry mix products as well as ready-to-drink teas (herbal and tealeaf based); fruit and vegetable juices and juice flavored beverages as well as juice drinks, nectars, concentrates, punches and “ades”; sweetened and flavored waters, both carbonated and still; sport/energy/health drinks; alcoholic beverages plus alcohol-free and other low-alcohol products including beer and malt beverages, cider, and wines (still, sparkling, fortified wines and wine coolers); other beverages processed with heating (infusions, pasteurization, ultra-high temperature, ohmic heating or commercial aseptic sterilization) and hot-filled packaging; and cold-filled products made through filtration or other preservation techniques.

According to a particular embodiment, the edible consumer product is in the form of hot or cold beverages such as herbal infusions, coffee, tea, botanicals.

According to a particular embodiment, the edible consumer product is a beverage comprising tea leaves, wherein the composition of the present invention is preferably present in an amount comprised between 0.01 and 0.15% by weight based on the total weight of the consumer product.

According to a particular embodiment, the edible consumer product is a tea bag, wherein the composition of the present invention is preferably present in an amount comprised between 1 and 15% by weight based on the total weight of the consumer product.

Fluid dairy products include, without limitation, non-frozen, partially frozen and frozen fluid dairy products such as, for example, milks, ice creams, sorbets and yogurts. Condiments include, without limitation, ketchup, mayonnaise, salad dressing, Worcestershire sauce, fruit-flavored sauce, chocolate sauce, tomato sauce, chili sauce, and mustard.

Baked goods include, without limitation, cakes, cookies, pastries, breads, donuts and the like.

Bakery fillings include, without limitation, low or neutral pH fillings, high, medium or low solids fillings, fruit or milk based (pudding type or mousse type) fillings, hot or cold make-up fillings and non-fat to full-fat fillings.

Suitable flavor base consumer products may be any foodstuff base, e.g. foods or beverages. Suitable foodstuff bases, e.g. foods or beverages, can be fried or not, as well as frozen or not, low fat or not, marinated, battered, chilled, dehydrated, instant, canned, reconstituted, retorted or preserved. Typical examples of said foodstuff bases include:
a seasonings or condiment, such as a stock, a savory cube, a powder mix, a flavored oil, a sauce (e.g. a relish, barbecue sauce, a dressing, a gravy or a sweet and/or sour sauce), a salad dressing or a mayonnaise;
a meat-based product, such as a poultry, beef or pork-based product, a seafood, surimi, or a fish sausage;
a soup, such as a clear soup, a cream soup, a chicken or beef soup or a tomato or asparagus soup;
a carbohydrate-based product, such as instant noodles, rice, pasta, potatoes flakes or fried, noodles, pizza, tortillas, wraps;
a dairy or fat product, such as a spread, a cheese, or regular or low fat margarine, a butter/margarine blend, a butter, a peanut butter, a shortening, a processed or flavored cheese;
a savory product, such as a snack, a biscuit (e.g. chips or crisps) or an egg product, a potato/tortilla chip, a microwave popcorn, nuts, a bretzel, a rice cake, a rice cracker, etc;
an imitation product, such as a dairy (e.g a reformed cheese made from oils, fats and thickeners) or seafood or meat (e.g. a vegetarian meat replacer, veggie burgers) analogue; or “a pet or animal food.

According to an embodiment, the edible product has a water activity of below 0.5.

Water activity is a well-known parameter of expressing how much free water exists in a water-containing composition.

Water activity (aw) is the partial vapor pressure of water in a substance divided by the standard state partial vapor pressure of water. In the field of food science, the standard state is most often defined as the partial vapor pressure of pure water at the same temperature.

The water activity a_{w} is defined as follows p/p*

where p is the partial vapor pressure of water in the solution, and p* is the partial vapor pressure of pure water at the same temperature.

Aw is an intrinsic properties of a composition can be easily determined by different methods such as resistive electrolytic, a capacitance or a dew point hygrometer.

Water activity has been determined at 25° with a Rotronic Hygrolab cell with four decimal digit and calibrated with saturated salt solutions, USING SUPPLIER Quick Aw® function estimating Aw after 5 to 6 min equilibration.

According to an embodiment, the composition of the present invention is used in an amount comprised between 0.001% and 15% by weight based on the total weight of the consumer product.

Another object of the invention is a dry composition comprising:
an insoluble food carrier,
a coating on the insoluble carrier, wherein the coating comprises:
   at least one water-soluble carrier material,
   at least one nutrient, and
   at least one taste modulator.

The insoluble food carrier is preferably selected from the group consisting of flowers, leaves, beans, seeds, cereals, algae, fruit pieces, vegetable pieces, powders, and particles, more preferably preferably the insoluble food carrier is selected from the group consisting of tea leaves and coffee beans. The leaves may be whole leaves, cut leaves, ground leaves, powdered leaves, in particular in form of free-flowing powders, or particles. The coffee beans may be unground or ground coffee beans.

In a particular embodiment, the insoluble food carrier is selected from the group consisting of an herbal carrier, a fruit carrier, and other botanicals.

In a particular embodiment, the insoluble food carrier may be algae, preferably seaweed.

In a particular embodiment, the insoluble food carrier is one or more fruit pieces. The one or more fruit pieces may stem from the same type of fruit or from different types of fruits. The one or more fruit pieces may stem from e.g. apples, pears, oranges, mandarins, limes, nectarines, apricots, peaches, plums, bananas, mangoes, strawberries, raspberries, blueberries, kiwifruit, passionfruit, and/or watermelons.

In a particular embodiment, the insoluble food carrier is one or more vegetable pieces. The one or more vegetable pieces may stem from the same type of vegetable or from different types of vegetables.

### EXAMPLES

The invention will now be described in further detail by way of the following examples.

### Example 1

### Preparation of Composition According to the Invention (in the Form of a Particle)

### General Protocol

The ingredients of the following tables were weighted and blended in a mixing bowl starting with the solid ones and adding finally the water. The mixture was then extruded using a 16 mm lab extruder from Thermo Electron (Germany). The extrusion parameters were as follow: Feeder throughput 400 g/h, die temperature 112° C., 4 barrels with temperatures ranged from 20° C. to 112° C. The single hole of the die has an inner diameter of 1 mm. Screw speed was set at 300 rpm.

After establishing steady state extrusion conditions, extrudate was chopped into discrete particles of about 1.5 mm using a rotary knife and collected through a cyclone.

The following particle composition were prepared according to the general protocol.

TABLE 1
Particle composition comprising iron as nutrient
and comprising Phloretin as taste modulator

| | | Comparative | |
|---|---|---|---|
| Ingredients | | particle X1 | Particle A |
| Iron (ferrous lactate) | Nutrient | 13.5 | 13.5 |
| Phloretin ¹⁾ | Taste modulator | 0 | 4.6 |
| Modified starch ²⁾ | Carrier material | 7.5 | 7.5 |
| Maltodextrin 18 DE ³⁾ | Carrier material | 69.9 | 65.4 |
| Neobee | Lubricant | 2 | 2 |
| Lecithin | Lubricant | 1 | 1 |
| H₂O | | 6 | 6 |

¹⁾ Phloretin, Origin Ferrer
²⁾ Capsul ® (Ingredion)
³⁾ Maltodextrin (Roquette)

TABLE 2
Particle composition comprising iron as nutrient
and comprising Naringenin as taste modulator

| | | Comparative | |
|---|---|---|---|
| Ingredients | | particle X2 | Particles B |
| Iron (ferrous lactate) | Nutrient | 13.5 | 13.5 |
| Naringenin ¹⁾ | Taste modulator | 0 | 4.6 |
| Modified starch ²⁾ | Carrier material | 7.5 | 7.5 |
| Maltodextrin 18 DE ³⁾ | Carrier material | 69.9 | 65.4 |
| Neobee | Lubricant | 2 | 2 |
| Lecithin | Lubricant | 1 | 1 |
| H₂O | | 6 | 6 |

¹⁾ Naringenin, Origin Ferrer
²⁾ Capsul ®, Origin:Ingredion
³⁾ Maltodextrin (Roquette)

TABLE 3
Particle composition comprising Vitamin B6 as nutrient
and comprising Phloretin as taste modulator

| | | Comparative | |
|---|---|---|---|
| Ingredients | | particle X3 | Particles C |
| Vitamine B6 | Nutrient | 0.51 | 0.51 |
| Phloretin ¹⁾ | Taste modulator | 0 | 4.6 |
| Modified starch ²⁾ | Carrier material | 9.15 | 8.59 |
| Maltodextrin 18 DE ³⁾ | Carrier material | 82.34 | 77.3 |
| Neobee | Lubricant | 2 | 2 |
| Lecithin | Lubricant | 1 | 1 |
| H₂O | | 6 | 6 |

¹⁾ Phloretin, Origin Ferrer
²⁾ Capsul ®, Origin:Ingredion
³⁾ Maltodextrin (Roquette)

TABLE 4
Particle composition comprising Vitamin B6 as nutrient
and comprising Naringenin as taste modulator

| Ingredients | | Comparative particle X4 | Particles D |
|---|---|---|---|
| Vitamine B6 | Nutrient | 0.51 | 0.51 |
| Naringenin ¹⁾ | Taste modulator | 0 | 4.6 |
| Modified starch ²⁾ | Carrier material | 9.15 | 8.59 |
| Maltodextrin 18 DE ³⁾ | Carrier material | 82.34 | 77.3 |
| Neobee | Lubricant | 2 | 2 |
| Lecithin | Lubricant | 1 | 1 |
| H₂O | | 6 | 6 |

¹⁾ Naringenin, Origin Ferrer
²⁾ Capsul ®, Origin: Ingredion
³⁾ Maltodextrin (Roquette)

TABLE 5
Particle composition comprising Vitamin E as nutrient
and comprising Phloretin as taste modulator

| Ingredients | | Comparative particle X5 | Particles E |
|---|---|---|---|
| Vitamine E | Nutrient | 4.5 | 4.5 |
| Phloretin ¹⁾ | Taste modulator | 0 | 4.6 |
| Modified starch ²⁾ | Carrier material | 9.95 | 9.1 |
| Maltodextrin 18 DE ³⁾ | Carrier material | 77.85 | 73.8 |
| Neobee | Lubricant | 2 | 2 |
| Lecithin | Lubricant | 1 | 1 |
| H₂O | | 6 | 6 |

¹⁾ Phloretin, Origin Ferrer
²⁾ Capsul ®, Origin: Ingredion
³⁾ Maltodextrin (Roquette)

TABLE 6
Particle composition comprising Vitamin E as nutrient
and comprising Naringenin as taste modulator

| | | Comparative particle | |
|---|---|---|---|
| Ingredients | | X6 | Particles F |
| Vitamine E | Nutrient | 4.5 | 4.5 |
| Naringenin ¹⁾ | Taste modulator | 0 | 4.6 |
| Modified starch ²⁾ | Carrier material | 9.95 | 9.1 |
| Maltodextrin 18 | Carrier material | 77.85 | 73.8 |
| DE ³⁾ | | | |
| Neobee | Lubricant | 2 | 2 |
| Lecithin | Lubricant | 1 | 1 |
| H₂O | | 6 | 6 |

¹⁾ Naringenin, Origin Ferrer
²⁾ Capsul ®, Origin: Ingredion
³⁾ Maltodextrin (Roquette)

TABLE 7
Particle composition comprising Vitamin D2 as nutrient
and comprising Phloretin as taste modulator

| Ingredients | | Particles G |
|---|---|---|
| Vitamin D2 | Nutrient | 6 |
| Phloretin ¹⁾ | Taste modulator | 4.6 |
| Modified starch ²⁾ | Carrier material | 9.1 |
| Maltodextrin 18 DE ³⁾ | Carrier material | 71.3 |
| Neobee | Lubricant | 2 |
| Lecithin | Lubricant | 1 |
| H₂O | | 6 |

¹⁾ Phloretin, Origin Ferrer
²⁾ Capsul ®, Origin: Ingredion
³⁾ Maltodextrin (Roquette)

TABLE 8
Particle composition comprising Vitamin D2 as nutrient
and comprising Naringenin as taste modulator

| Ingredients | | Particles H |
|---|---|---|
| Vitamin D2 | Nutrient | 6 |
| Naringenin 1) | Taste modulator | 4.6 |
| Modified starch 2) | Carrier material | 9.1 |
| Maltodextrin 18 | Carrier material | 71.3 |
| DE 3) | | |
| Neobee | Lubricant | 2 |
| Lecithin | Lubricant | 1 |
| H₂O | | 6 |

1) Naringenin, Origin Ferrer
2) Capsul ®, Origin: Ingredion
3) Maltodextrin (Roquette)

TABLE 9
Particle composition comprising Vitamin B12 as nutrient
and comprising Phloretin as taste modulator

| Ingredients | | Particles I |
|---|---|---|
| Vitamin B12 | Nutrient | 1 |
| Phloretin ¹⁾ | Taste modulator | 4.6 |
| Modified starch ²⁾ | Carrier material | 8.1 |
| Maltodextrin 18 DE ³⁾ | Carrier material | 77.3 |
| Neobee | Lubricant | 2 |
| Lecithin | Lubricant | 1 |
| H₂O | | 6 |

¹⁾ Phloretin, Origin Ferrer
²⁾ Capsul ®, Origin: Ingredion
³⁾ Maltodextrin (Roquette)

TABLE 10
Particle composition comprising Vitamin B12 as nutrient
and comprising Naringenin as taste modulator

| Ingredients | | Particles J |
|---|---|---|
| Vitamin B12 | Nutrient | 1 |
| Naringenin ¹⁾ | Taste modulator | 4.6 |
| Modified starch ²⁾ | Carrier material | 8.1 |
| Maltodextrin 18 DE ³⁾ | Carrier material | 77.3 |
| Neobee | Lubricant | 2 |
| Lecithin | Lubricant | 1 |
| H₂O | | 6 |

¹⁾ Naringenin, Origin Ferrer
²⁾ Capsul ®, Origin: Ingredion
³⁾ Maltodextrin (Roquette)

### Example 2

### Performance of the Composition According to the Invention

### Protocol

The particles prepared in example 1 were included in a lemon-flavored drink (here below the formulation) or in water at a concentration of 0.1% rtd (ready-to-drink) for Iron, 0.06% rtd for vitamin B6, 0.05% rtd for vitamin E comparing encapsulated with nutrient but without taste modulator vs encapsulated with nutrient and with taste modulator (nutrient being dosed at the same level in both cases)

TABLE 11
Lemon flavored drink

| Ingredients | Quantity (in g) |
|---|---|
| Sugar | 50 |
| Citric acid anhydrous E330 | 2 |
| Potassium sorbate E202 | 0.15 |
| Lemon flavor | 0.6 |
| Water | 973.94 |

To measure the performance of this invention, tasting sessions were organized showing the benefit of adding taste modulators to encapsulated product containing vitamins and/or minerals.

Samples were presented and tasted by a panel composed of trained panelists in a randomized order and attributes were rated on a 0-10 scale.

### Results

TABLE 12
Performance of particles C (Vitamin B6/Phloretin) and comparative
particles X3 (Vitamin B6) in the lemon-flavored drink

| Descriptor | Comparative X3 | Particles C |
|---|---|---|
| Overall flavor | 5.3 | 5.7 |
| Peely | 3.11 | 3.57 |
| Fatty Sweet | 2.76 | 1.74 |
| Sweet | 3.61 | 4.53 |
| Bitter | 1.22 | 1.14 |
| Astringent | 2.41 | 1.94 |
| Cardboard | 1.93 | 0.72 |

TABLE 13
Performance of particles A (Iron/Phloretin) and comparative
particles X1 (Iron) in the lemon-flavored drink

| Descriptor | Comparative X1 | Particles A |
|---|---|---|
| Juicy Sweet | 4.42 | 4.54 |
| Astringent | 2.59 | 2.18 |
| Overall flavor | 5.60 | 6.46 |
| Lime | 3.74 | 5.13 |
| Sweet | 4.56 | 5.49 |
| Lemon | 4.9 | 5.76 |
| Long lasting sweet | 2.9 | 4.08 |

TABLE 14
Performance of particles A (Iron/Phloretin)
and comparative particles X1 (Iron) in water

| Descriptor | Comparative X1 | Particles A |
|---|---|---|
| Sweetness | 1.12 | 2.46 |
| Bitterness | 0.88 | 0.54 |
| Oily | 1.54 | 1.29 |
| Metallic | 2.13 | 1.50 |
| Cardboard | 1.17 | 0.88 |
| Long Lasting Sweet | 1.13 | 2.25 |

TABLE 15
Performance of particles E (Vitamin E/Phloretin)
and comparative particles X5 (Vitamin E) in water

| Descriptor | Comparative particle X5 | Particles E |
|---|---|---|
| Sweetness | 0.87 | 1.79 |
| Oily | 1.54 | 1.25 |
| Metallic | 2.00 | 1.17 |
| Cardboard | 1.71 | 0.96 |
| Long Lasting Sweet | 0.42 | 1.50 |

TABLE 16
Performance of particles C (Vitamin B6/Phloretin)
and comparative particles X3 (Vitamin B6) in water

| Descriptor | Comparative particle X3 | Particles C |
|---|---|---|
| Sweetness | 0.92 | 1.88 |
| Oily | 2.75 | 2.00 |
| Rancid | 2.21 | 1.29 |
| Cardboard | 2.46 | 1.58 |
| Long Lasting Sweet | 0.42 | 1.04 |

TABLE 17
Performance of particles D (Vitamin B6/naringenin)
and comparative particles X4 (Vitamin B6) in water

| Descriptor | Comparative particle X4 | Particles D |
|---|---|---|
| Bitterness | 1.13 | 0.67 |
| Oily | 3.46 | 2.08 |
| Rancid | 2.38 | 1.21 |
| Cardboard | 2.79 | 1.67 |
| Long Lasting Sweet | 0.79 | 1.50 |

### Conclusion

Significant results were clearly obtained when a taste modulator is added to the formulation. Positive effects were observed for example on overall flavor intensity, sweetness, oily, metallic, rancid off-note, cardboard and long-lasting sweet.

### Example 3

### Chewing-Gum Comprising the Composition of the invention

The particles E-H were included in a chewing-gum composition at a concentration of 2% by weight based on the total weight of the chewing gum composition.

TABLE 18
Chewing gum composition

| Ingredients | % |
|---|---|
| Gum base | 31 |
| Sorbitol P | 49.72 |
| Lycasin ® | 17 |
| Glycerin | 2 |
| Sucralose | 0.1 |
| Acesulfam K | 0.18 |
| | 100 |

### Example 4

### Meat Analogue Comprising the Composition of the Invention

The particles G-J were included in a meat analogue composition (soy protein or pea protein-based meat analogue compositions) at a concentration of 0.007% by weight for particles G and H and at a concentration of 0.06% for particles I and J based on the total weight of the meat analogue composition.

1. A composition comprising:
at least one water-soluble carrier material,
at least one nutrient, and
at least one taste modulator.

2. The composition according to claim 1, wherein the nutrient is selected from the group consisting of a vitamin, a mineral, an antioxidant, a botanical extract, and mixtures thereof.

3. The composition according to claim 2, wherein the nutrient is selected from the group consisting of a vitamin, a mineral, and mixtures thereof.

4. The composition according to claim 1, wherein it comprises a flavor.

5. The composition according to claim 1, wherein it comprises between 0.1 and 50% by weight of nutrient based on the total weight of the composition.

6. The composition according to claim 1, wherein it comprises at least one mineral selected from the group consisting of iron, selenium, zinc, magnesium, calcium, copper, sodium, potassium, phosphor, silver, gold, sulphur, and mixtures thereof.

7. The composition according to claim 1, wherein it comprises at least one vitamin selected from the group consisting of vitamin E, vitamin B₆, vitamin A, vitamin C, vitamin D, vitamin B₁, vitamin B₂, vitamin B₃, vitamin B₅, vitamin B₆, vitamin B₇, vitamin B₈, vitamin B₉, vitamin B₁₂, Inositol, Vitamin D₁, vitamin D₂, vitamin D₃, vitamin D₄, vitamin D₅, Vitamin K, and mixtures thereof.

8. The composition according to claim 1, wherein it comprises between 50 and 95% by weight of a water-soluble carrier material based on the total weight of the composition.

9. The composition according to claim 1, wherein the water-soluble carrier material is selected from the group consisting of a starch derivative, a gum, a fiber, a polysaccharide, a protein, a soluble flour, and mixtures thereof.

10. The composition according to claim 1, wherein it comprises between 0.5 and 25% by weight of a taste modulator based on the total weight of the composition.

11. The composition according to claim 1, wherein the taste modulator is chosen in selected from the group consisting of bitterness masker compound, sourness masker compound, umami enhancer compound, cooling enhancer compound, bitterness blocking compound, bitter masking compound, sour taste modulating compound, mouthfeel modifying compound, flavor masking compound, astringency masker compound, salty or metallic taste masker compound, sweetness enhancer compound, salivating enhancer compound, and mixtures thereof.

12. The composition according to claim 1, wherein the taste modulator is chosen in selected from the group consisting of N-(1-((4-amino-2,2-dioxo-1H-benzo[c][1,2,6]thiadiazin-5-yl)oxy)-2-methylpropan-2-yl)isonicotinamide, or any of its comestbly acceptable salts, 3-hydroxy benzoic acid, hesperetin dihydrochalcone, hesperetin dihydrochalcone-4′-O′glucoside, neohesperetin dihydrochalcone, brazzein, hesperidin, phyllodulcin, naringenin, naringin, phloretin, glucosylated steviol glycosides, (2R,3R)-3-acetoxy-5,7,4′-trihydroxyflavanone, (2R,3R)-3-acetoxy-5,7,3′-trihydroxy-4′-methoxyflavanone, rubusosides, thaumatin, monellin, miraculin, glycyrrhizin and comestible acceptable salts thereof (such as the mono-ammonium salt), naringin dihydrochalcone, myricetin, nobiletin, polymethoxyflavones, mixed methoxy- and hydroxyflavones, quercetin, 3-((4-amino-2,2-dioxo-1H-benzo[c][1,2,6]thiadiazin-5-yl)oxy)-2,2-dimethyl-N-propyl-propanamide, (2R,4R)-1,2,4-trihydroxy-heptadec-16-ene, (2R,4R)-1,2,4-trihydroxyheptadec-16-yne, (3R,5S)-1-(4-hydroxy-3-methoxyphenyl)decane-3,5-diol diacetate, N-(heptan-4-yl)benzo-[d][1,3]dioxole-5-carboxamide, N-ethyl-N-(thiophen-2-ylmethyl)-2-(p-tolyloxy)acetamide, N-(1H-pyrazol-3-yl)-N-(thiophen-2-ylmethyl)-2-(p-tolyloxy)acetamide, 2-(4-fluorophenoxy)-N-(1H-pyrazol-3-yl)-N-(thiophen-2-ylmethyl)acetamide, 2-(2-hydroxy-4-methylphenoxy)-N-(1H-pyrazol-3-yl)-N-(thiophen-2-ylmethyl)-acetamide, 2-((2,3-dihydro-1H-inden-5-yl)oxy)-N-(1H-pyrazol-3-yl)-N-(thiophen-2-ylmethyl)-acetamide, 2-((2,3-dihydro-1H-inden-5-yl)oxy)-N-(1H-pyrazol-3-yl)-N-(thiazol-5-ylmethyl)-acetamide, 2-((5-methoxy benzofuran-2-yl)oxy)-N-(1H-pyrazol-3-yl)-N-(thiophen-2-ylmethyl)-acetamide, (E/Z)-2-methyl-2-butenal, (E/Z)-2-isopropyl-5-methyl-2-hexenal, 3-(1-((3,5-dimethylisoxazol-4-yl)-methyl)-1H-pyrazol-4-yl)-1-(3-hydroxybenzyl)-imidazolidine-2,4-dione, 4-(2,2,3-trimethyl-cyclopentyl)butanoic acid, 3β-hydroxy dihydrocostunolide, 3β-hydroxypelenolide, probenecid, sakuranetin, 6-methoxysakuranetin, jaceosidin, 4′-fluoro-6-methoxyflavonone, 6,3′-dimethoxyflavonone, 6-methoxyflavonone, γ-aminobutyric acid, Nα,Nα-bis(carbomethyl)-L-lysine, (+/−) abscisic acid, sodium gluconate, monosodium glutamate, sodium acetate, homoeriodictyol, sterubin, eriodictyol, 2,4,dihydrobenzoic acid, neodiosmin, 1-carboxymethyl-5-hydroxy-2-hydroxymethylpyridinium, flavan-3-spiro-C-glycosides, poly-γ-glutamic acid, α,α-trehalose, taurine, (2)-gingerdione, 2,4,-dihydroxybenzoic acid, L-theanine, enterodiol, lariciresinol, enterolactone, matairesinol, and mixtures thereof.

13. The composition according to claim 1, wherein it is an extruded particle.

14. The composition according to claim 1, wherein it is a coating material.

15. An edible consumer product comprising the composition of claim 1.

16. The composition according to claim 1, wherein it comprises between 0.5 and 30% by weight of nutrient based on the total weight of the composition.

17. The composition according to claim 1, wherein it comprises between 60 and 90% by weight of a water-soluble carrier material based on the total weight of the composition.

18. The composition according to claim 1, wherein it comprises between 2 and 15% by weight of a taste modulator based on the total weight of the composition.

19. An edible consumer product comprising the composition of claim 1 in the form of hot or cold beverages, herbal infusions, coffee, tea, or botanicals.
